(19) United States
(12) Patent Application Publication
(10) Pub. No.: US 2015/0048169 A1
(43) Pub. Date: Feb. 19, 2015

(54) CARRIER ELEMENT WITH A QR CODE

(71) Applicant: Fotovio GmbH, Munchen (DE)

(72) Inventor: Christian Doberschutz, Munchen (DE)

(73) Assignee: FOTOVIO GMBH, Munchen (DE)

(21) Appl. No.: 14/456,051

(22) Filed: Aug. 11, 2014

(30) Foreign Application Priority Data
Aug. 13, 2013 (DE) 202013103662.5

(51) Int. Cl. G06K 19/06; G06K 1/12

(52) U.S. Cl. CPC G06K 19/06037; G06K 19/06046; G06K 1/121
USPC 235/488; 235/494; 270/1.01

(57) ABSTRACT

A carrier element with a QR code, including a decorative area having a decorative design with an inner area (1) with the QR code and an outer area (2) that is adjacent to the inner area (1) or at least partially surrounds the inner area. The decorative design has, in the outer area (2), an outer design with pattern sections that are combined from elements of QR codes.

### INCORPORATION BY REFERENCE

The following documents are incorporated herein by reference as if fully set forth: German Patent Application No. 20 2013 103 662.5, filed Aug. 13, 2013.

### BACKGROUND

The invention relates to a carrier element with a QR code.

A QR code, i.e., a Quick Response code, is a two-dimensional barcode that can be read, e.g., by correspondingly equipped cellular phones. For example, access data to an application made available over the Internet is encrypted in a QR code.

DE 20 2008 012 934 U1 describes a carrier element for access points to information systems and this carrier element can be used for electronic services that are location-based or specific to an object or a person. Various different access paths to an information system can be combined and made available on the carrier element. In one embodiment, the carrier element is constructed as a sticker.

From DE 10 2006 049 578 A1, informational carriers are known that have an informational symbol, e.g., a QR code, visible from the outside and are suitable for changing the informational symbol that is visible from the outside such that it cannot be read by information devices.

The subject matter of DE 20 2012 006 708 U1 is an advertising tag that is to be fastened flexibly to moving and stationary objects and is provided with contents and information, e.g., in the form of quick response codes.

JP 2008 125 973 A describes QR codes on round, triangular, and square stickers. Here, the edges of the stickers around each QR code are constructed as white areas.

### SUMMARY

The objective of the invention is to develop a visually appealing, multi-purpose carrier element with a QR code on a surface.

The objective is met with a carrier element with a QR code and method of producing such a carrier having one or more features of the invention as discussed in detail below and in the claims.

A carrier element according to the invention with a QR code is provided with a decorative area having a decorative design. The decorative area is sub-divided into an inner area with the QR code and an outer area that is adjacent to the inner area and/or at least partially surrounds this inner area. The decorative design has, in the outer area, an outer design with pattern sections that are assembled from elements of QR codes.

The advantage of the carrier element according to the invention is that it has a decorative representation of the QR code due to the outer design, wherein the legibility of the QR code is maintained for information devices. In contrast to the change described in DE 10 2006 049 578 A1 to the outer area around a QR code that makes this code unreadable, for the use of elements of the QR code for the outer design, the markings, for example, the three position designs, the orientation designs, and optionally a light boundary line of the QR code, are still recognizable as such. An information device therefore can detect the orientation and size of the QR code and read the code.

In one embodiment, the pattern sections of the outer design have dark and light pattern elements, also called symbols, into which the QR code is divided outside of markings. Here, dark pattern elements are colored completely, i.e., uniformly, dark, e.g., black, and light pattern elements are colored completely, i.e., uniformly, light, e.g., white. Pattern elements are square like the inner area with the QR code. They have a uniform side length. The pattern sections of the outer design are, for example, arbitrary sections of the QR code outside of the markings or new sections assembled from the pattern elements.

In one embodiment, pattern sections on the outer edge of the outer area have parts of pattern elements adapted to the outer edge.

In one embodiment, the outer design has at least one text field and/or at least one element, for example, a graphical element or a separate design element.

In one embodiment, the outer design, at least at the pattern sections, has a boundary line whose width corresponds to 0.5 to 3 times the side length of a pattern element.

In one embodiment, the distribution of dark and light pattern elements into the pattern sections corresponds to that of the QR code outside of markings.

A carrier element is constructed in one alternative as a flat decorative element that has a decorative layer and optionally a lower carrier layer. The top side of the decorative layer is constructed as a decorative area with the decorative design.

Here, in one embodiment the contours of the flat decorative element correspond to the contours of the decorative design.

In one embodiment, the flat decorative element is constructed as an adhesive label, also called a sticker. Here, its carrier layer is constructed, for example, as an adhesive layer and the decorative layer is constructed from paper or plastic.

In one alternative, a flat decorative element has only one decorative layer that can be applied on a substrate. The flat decorative element is produced, for example, from fabric, printed with the decorative design, and can be sewn, for example, on an article of clothing or bonded with an adhesive agent.

In one embodiment, the carrier element is constructed as a substrate, wherein the decorative design for forming the decorative area is applied, e.g., pressed or stamped, directly onto the carrier element. Substrates are paper articles, for example, greeting cards, folded cards, or invitation cards. Substrates are gifts, photo books, photo albums, wedding books/albums, books, for example, cookbooks, as well as newspapers, journals, and magazines. Substrates are packages made from paper or plastic. Substrates are pieces of jewelry made from metal. Substrates are advertising articles.

The decorative designs are, e.g., black/white, gray/white, black/gray, or color/white, or with different degrees of brightness of gray/gray or color/color.

A method of forming a carrier element according to the invention with a QR code surrounded with a decorative area having a decorative design is also provided. The carrier element is cut to a desired outer periphery in accordance with the design to form a decorative area. The decorative area is sub-divided into an inner area and an outer area. A QR code is printed or located in the inner area of the carrier element. A decorative design formed of pattern sections that are assembled from parts of QR codes is printed or located on the outer area, that is adjacent to the inner area and/or at least partially surrounds the inner area.

In another aspect, pattern sections of the QR code in the inner area are square, and the pattern sections of the decorative design include arbitrary sections of the QR code.

### BRIEF DESCRIPTION OF THE DRAWINGS

The invention is explained further with reference to examples shown schematically in the drawing. Shown are:

FIGS. 1a-c schematic diagrams of carrier elements with decorative designs shown enlarged and constructed as flat decorative elements, e.g., as stickers;

FIGS. 2a-h schematic diagrams of flat decorative elements with decorative designs, including that of FIG. 1; and

FIGS. 3a-g schematic diagram of carrier elements with decorative designs in the form of different products.

### DETAILED DESCRIPTION OF THE PREFERRED EMBODIMENTS

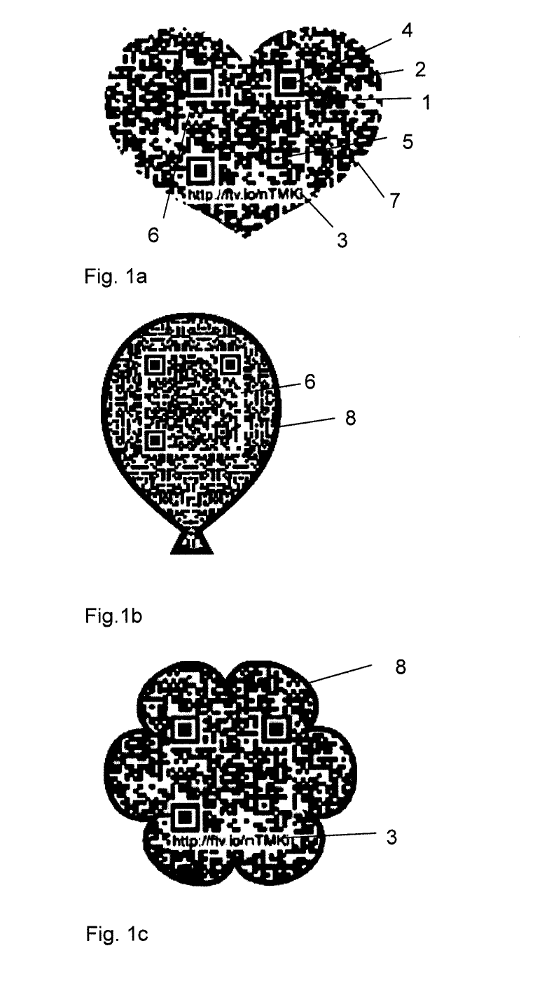

In FIGS. 1a-c, three carrier elements constructed as flat decorative elements are shown that each have a QR code on their top side.

The decorative element of FIG. 1a has, on the top side of its decorative layer, a decorative area with a decorative design that symbolizes a heart. The decorative area is divided into an inner area 1 with the QR code and an outer area 2 with an outer design. The outer area is adjacent to the inner area 1 and completely surrounds the inner area 1 with the QR code.

The outer area 2 has a text field 3. In the text field 3, for example, a link to an Internet site is specified. This allows information to be indicated in an encrypted fashion or part of the information to be indicated also in an unencrypted fashion.

The QR code defines the inner area 1 as a square area. It contains, for example, at certain positions, namely at the two left corners and the upper right corner, a position design 4 and, in the region of the lower corner, an orientation design 5.

The decorative design has, in the outer area, in addition to the text field 3, an outer design with at least one pattern section that is assembled from elements of the QR code.

The pattern sections of the outer design have dark and light pattern elements into which the QR code is divided outside of the markings, namely the position design 4 and the orientation design 5. Here, dark pattern elements are colored uniformly dark, e.g., black, and light pattern elements are colored uniformly light, e.g., white. The pattern elements are square with a uniform side length. On its edge, the QR code had a thinner boundary line 6, as can be barely seen in FIG. 1a, whose color corresponds to the color of the light pattern points. The pattern elements are also called symbols.

The pattern sections of the outer design are assembled from the pattern elements described above. Elements of the pattern sections are, for example, arbitrary sections of the QR code outside of the markings or new sections assembled from the pattern elements.

By selecting sections of the existing QR code, the distribution of the dark and light pattern elements in the outer design corresponds to that of the QR code.

New sections made from pattern elements are assembled corresponding to the distribution of the dark and light pattern elements. One possible type of distribution is an essentially equal number of dark and light pattern elements. One possibility for determining the distribution is, for example, determining the frequency of different numbers of adjacent identical pattern elements.

The contours of the decorative area, that is, the contours of the flat decorative element and, in this example, the contours of the outer area, have the shape of a heart. At the positions at which the contours, i.e., the outer edge of the outer area, do not run along a pattern element, for example, at an angle through a possible pattern element, only one part 7 of the pattern element lying within the outer boundary is provided. That is, the outer design has, at the edge of the outer area, parts of pattern elements adapted to the outer boundary.

The flat decorative element of FIG. 1a is constructed so that it can be applied on a substrate. In this example, the flat decorative element is constructed as an adhesive label or sticker for application on a substrate, for example, on a card, a book, or a package. In addition to the decorative layer made, for example, from paper, it has a carrier layer constructed as an adhesive layer. The decorative design is printed on the decorative layer.

FIG. 1b has a flat decorative element that corresponds to that of FIG. 1a up to the following. The decorative design symbolizes a balloon. The outer design has corresponding contours and on the outer edge a boundary line 8 following the contours. The thickness of the boundary line corresponds to approximately 2 times the side length of a pattern element. The outer design is formed of pattern sections; it is constructed without a text field. The edge line 6 is somewhat thicker than that of the QR code of FIG. 1a.

FIG. 1c has a flat decorative element that corresponds to that of FIG. 1a up to the following: the decorative design symbolizes a flower with six flower petals. The outer design has corresponding contours and on the outer edge a boundary line 8 following the contours. The thickness of the boundary line 8 corresponds, for example, to the side length of one pattern element. The outer design has a text field 3. Incidentally, it is filled with pattern sections.

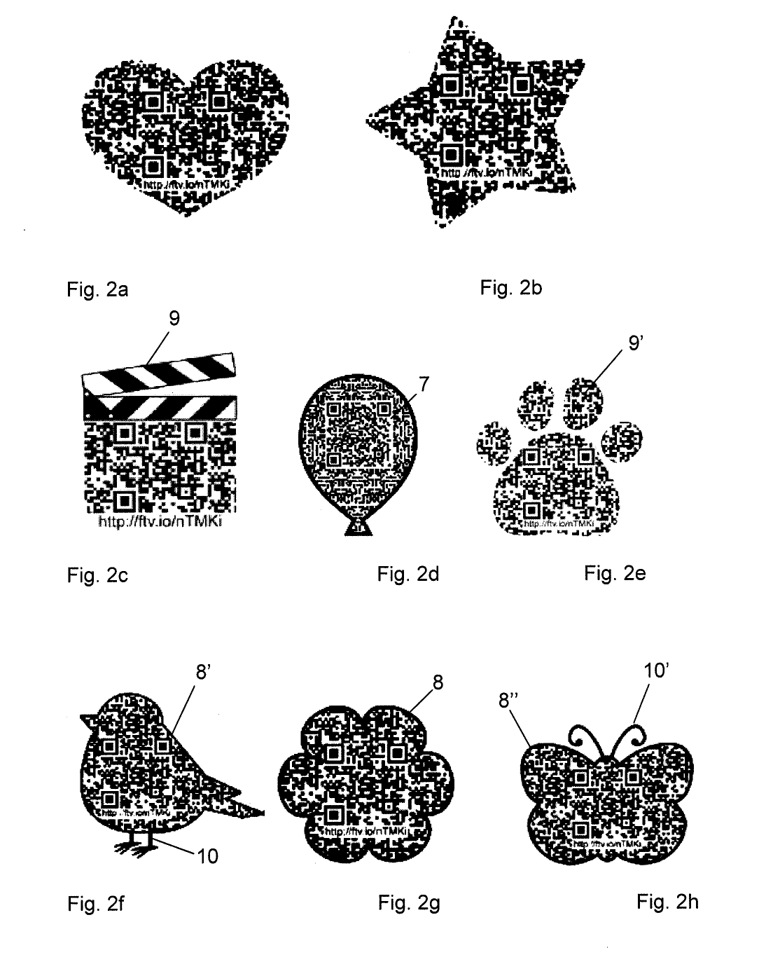

FIGS. 2a-h show, in addition to the flat decorative elements described above in FIGS. 2a, 2d, and 2g, additional flat decorative elements.

FIG. 2b has a flat decorative element that corresponds to that of FIG. 1a up to the following: the decorative design symbolizes a star, wherein the outer design has corresponding contours.

FIG. 2c has a flat decorative element that corresponds to that of FIG. 1a up to the following: the decorative design symbolizes a clapperboard. The outer design has corresponding contours and an additional graphical element 9. The outer design surrounds the QR code of the inner area 1. The graphical element 7 of the outer design forms a section of the outer area 2 adjacent to the upper edge of the inner area 1. The graphical element 9 symbolizes the two clapping elements of a clapperboard. On the two sides of the inner area 1, the outer design has pattern sections with elements of QR codes and on the lower edge of the inner area 1, a text field 3.

FIG. 2e has a flat decorative element that corresponds to that of FIG. 1a up to the following: the decorative design symbolizes a paw print. The outer design has contours corresponding to a middle part of the paw with pattern sections and also design elements 9 separate from the middle part with pattern elements that symbolize the toes of the paw.

In this example, a multi-part decorative design is arranged on the decorative area. The outer design of the decorative design has open areas between the parts of the design. The outer area 2 has corresponding open areas.

In one alternative, an outer area 2′ extends around the middle part and the toes. For making the diagram easier to understand, one edge of the outer area 2′ is drawn with dashed lines in FIG. 2c. The decorative design is one piece and also comprises the open intermediate areas.

FIG. 2f has a flat decorative element that corresponds to that of FIG. 1a up to the following: the decorative design symbolizes a bird. The outer design has corresponding contours, a boundary line 8 following the contours on the outer edge and also a graphical element 10 on the outside on the boundary line 8 that symbols the feet of the bird.

FIG. 2h has a flat decorative element that corresponds to that of FIG. 1a up to the following: the decorative design symbolizes a butterfly. The outer design has corresponding contours, a boundary line 8 following the contours on the outer edge, and also a graphical element 10 on the outside on the boundary line 8 that symbolizes the antenna of the butterfly.

In one alternative, the flat decorative element is constructed as a patch, for example, made from fabric, which can be sewn, for example, onto an article of clothing.

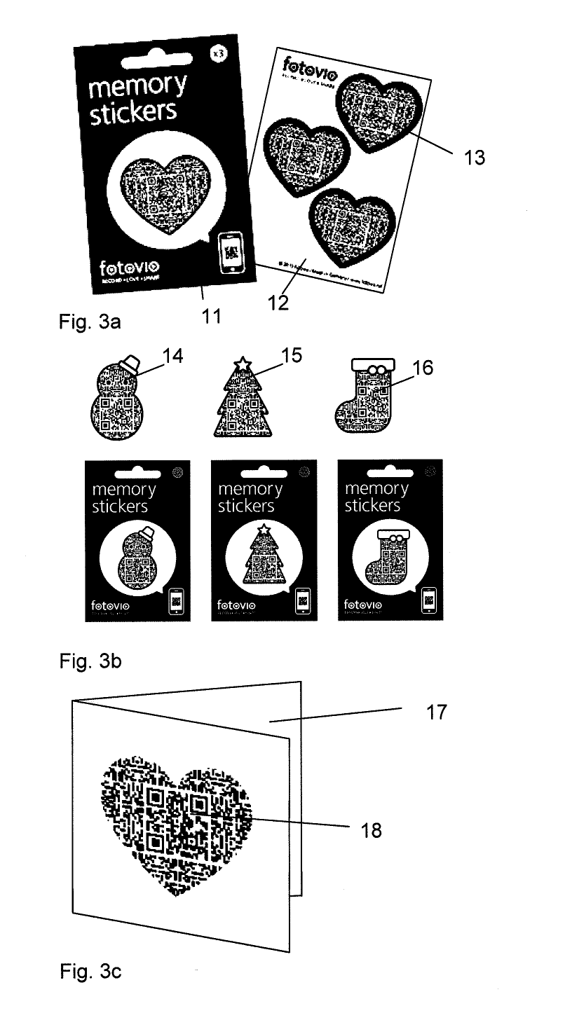

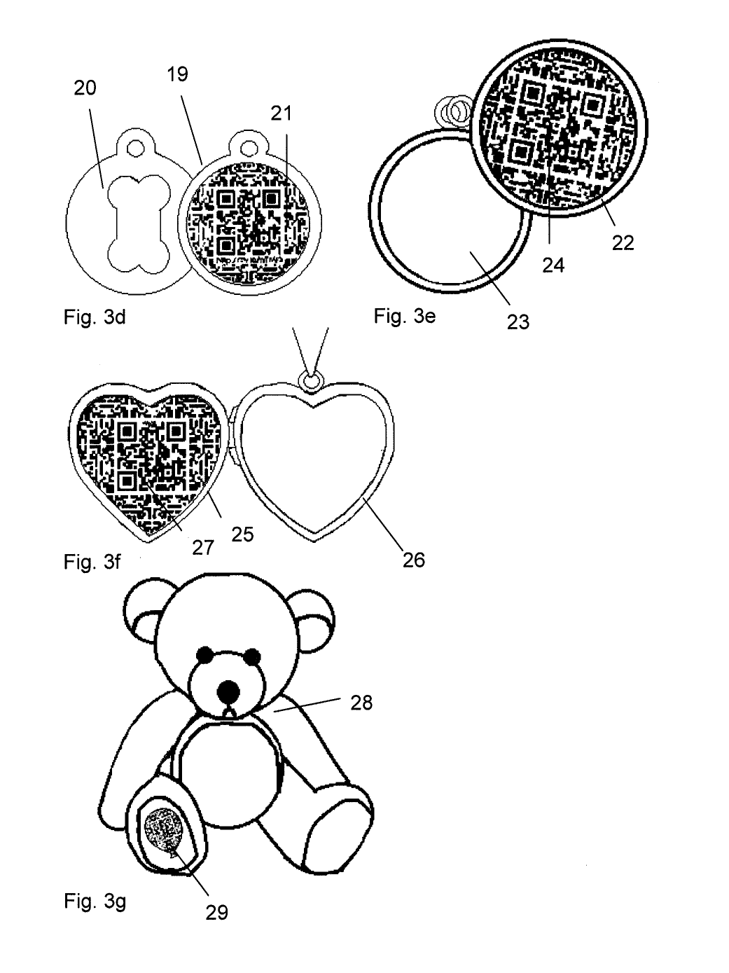

Additional products are shown in FIGS. 3a-g.

FIG. 3a shows an arrangement with a packaging sleeve 11 and a sheet 12 with three carrier elements constructed as stickers 13. The carrier elements are constructed as flat decorative elements. The carrier elements have a lower carrier layer and an upper decorative layer. The carrier layer is constructed as an adhesive layer.

The top side of the decorative layer is constructed as a decorative area, i.e., with a decorative design. The decorative design symbolizes a heart. The contours of the flat decorative element, namely the sticker 13, are shaped like a heart, i.e., they correspond to the contours of the decorative design. The three heart-shaped stickers 13 are arranged on the sheet 12 and constructed so that they can be peeled from this sheet. The sheet 12 is coated, e.g., with plastic.

FIG. 3b shows additional carrier elements constructed as stickers 14, 15, 16 and thus as flat decorative elements. This figure also shows the packaging sleeves for these elements. The contours of the sticker 14 and thus the decorative design symbolize a snowman. The contours of the sticker 15 symbolize a Christmas tree. And the contours of the sticker 16 symbolize a Christmas stocking.

FIG. 3c shows a carrier element that is constructed as a substrate, namely as a folded card 17. A decorative design 18 is applied directly on the carrier element for forming the decorative area. In this example, the decorative design is printed on the folded card. The contours of the decorative design are shaped like a heart. The decorative design symbolizes a heart.

FIG. 3d shows a carrier element that is constructed as a substrate, namely as a plate 19 of a dog tag made from two round plates 19, 20 that can be sealed to each other. A decorative design 21 is printed directly on the outer side of the plate 19. The contours of the decorative design are shaped like a circle.

FIG. 3e shows a carrier element that is constructed as a substrate, namely as a plate 22 of a piece of jewelry made from two round plates 22, 23 that can be sealed to each other. A decorative design 24 is printed directly on the outer side of the plate 22. The contours of the decorative design are shaped like a circle.

FIG. 3f shows a carrier element that is constructed as a substrate, namely as a plate 25 of a piece of jewelry made from two heart-shaped plates 25, 26 that can be sealed to each other. A decorative design 27 is printed directly on the outer side of the plate 25. The contours of the decorative design 27 are shaped like a heart.

In one alternative, the decorative design is stamped directly on the carrier element, on the outer side of the plate 25, to form the decorative area 27.

FIG. 3g shows a carrier element that is constructed as a substrate, namely, as a stuffed animal 28, a teddy bear. A decorative design 29 is applied, e.g., printed, directly on the carrier element, namely the stuffed animal 28, on the bottom side of a paw, to form the decorative area. The contours of the decorative design 29 correspond to those of a balloon. The decorative design symbolizes a balloon.

### LIST OF REFERENCE SYMBOLS

1 Inner area

2 Outer area

3 Text field

4 Position design

5 Orientation design

6 Light boundary line

7 Part of a pattern element

8 Boundary line

9 Separate graphical element

9′ Separate design element

10 Graphical element on the boundary line

11 Packaging sleeve

12 Sheet

13, 14, 15, 16 Sticker

17 Folded card

18 Decorative design, heart

19, 20 Plate

21 Decorative design, circle

22, 23 Plate

24 Decorative design, circle

25, 26 Plate

27 Decorative design, heart

28 Stuffed animal

29 Decorative design, balloon

1. A carrier element with a QR code, comprising a decorative area having a decorative design with an inner area (1) with the QR code and an outer area (2) that is adjacent to the inner area (1) or at least partially surrounds the inner area, and the decorative design has, in the outer area (2), an outer design with pattern sections that are combined from elements of QR codes.

2. The carrier element according to claim 1, wherein the pattern sections of the outer design have dark and light pattern elements into which the QR code is divided outside of markings, and the dark pattern elements are uniformly dark, and light pattern elements are uniformly light.

3. The carrier element according to claim 2, wherein the outer design has parts (7) of pattern elements adapted to the pattern sections on an outer boundary of the outer area.

4. The carrier element according to claim 1, wherein the outer design has at least one of a text field (3), a graphical element (9′, 10), or a design element (9).

5. The carrier element according to claim 1, wherein the outer design has, at least on the pattern sections, a boundary line (8) having a width that corresponds to 0.5 to 3 times a side length of a pattern element.

6. The carrier element according to claim 1, wherein a distribution of the dark and light pattern elements into the pattern sections corresponds to the outer area of the QR code outside of markings.

7. The carrier element according to claim 1, wherein the carrier element is comprised of a flat decorative element for application on a substrate with a decorative layer, and a top side of the decorative layer is constructed as the decorative area with the decorative design.

8. The carrier element according to claim 7, wherein the carrier element is comprised of the flat decorative element for application on a substrate with the decorative layer and a lower carrier layer.

9. The carrier element according to claim 7, wherein a contour of the flat decorative element corresponds to a contour of the decorative area.

10. The carrier element according to claim 7, wherein the carrier element comprises a sticker (13, 14, 15, 16).

11. The carrier element according to claim 1, wherein the carrier element comprises a substrate, and the decorative design is applied directly on the carrier element in order to form the decorative area.

12. The carrier element according to claim 1, wherein the decorative design is pressed or stamped on the carrier element.

13. A method of forming a carrier element with a QR code surrounded with a decorative area having a decorative design, comprising
cutting the carrier element to a desired outer periphery in accordance with a specified design to form a decorative area;
sub-dividing the decorative area into an inner area and an outer area;
printing or locating a QR code having pattern sections in the inner area of the carrier element;
printing or locating a decorative design of pattern sections that are assembled from parts of QR codes on the outer area, that is adjacent to the inner area and/or at least partially surrounds the inner area.

14. The method of claim 13, wherein the pattern sections of the QR code in the inner area are square, and the pattern sections of the decorative design include arbitrary sections of the QR code.
